(19) United States
(12) Patent Application Publication
(10) Pub. No.: US 2017/0151914 A1
(43) Pub. Date: Jun. 1, 2017

(54) AUTOMOBILE DATA RECORDER WITH DETACHABLE DISPLAY

(71) Applicant: NANJING ASIATEK TECHNOLOGY LTD., Nanjing (CN)

(72) Inventor: XIAO-LI HE, Shenzhen (CN)

(21) Appl. No.: 14/966,692

(22) Filed: Dec. 11, 2015

(30) Foreign Application Priority Data
Nov. 27, 2015 (CN) 201510840094.8

(51) Int. Cl. B60R 11/02; G06F 1/16; F16B 1/00

(52) U.S. Cl. CPC B60R 11/0229; F16B 1/00; G06F 1/16; F16B 2001/0064

(57) ABSTRACT

An automobile data recorder includes a bracket and display detachably mounted to the bracket. The bracket includes a base and an operation board secured to a side of the base. The base defines a receiving recess. The display is detachably mounted to the bracket in a usable position, where the display is vertically mounted to the base and abuts the operation board, or is in an idle position, where the display is horizontally mounted to the base and received in the receiving recess preventing dust from adhering on the display.

### FIELD

The subject matter herein generally relates to an automobile data recorder with a detachable display.

### BACKGROUND

An automobile data recorder is generally used in an automobile to record driving conditions outside the automobile. A display of the automobile data recorder is always positioned vertically in the automobile no matter if the automobile is moving or not.

### BRIEF DESCRIPTION OF THE DRAWINGS

Implementations of the present technology will now be described, by way of example only, with reference to the attached figures.

FIG. 1 is an exploded, isometric view of an embodiment of an automobile data recorder.

FIG. 2 is an isometric view of a display of the automobile data recorder of FIG. 1.

FIG. 3 is an assembled, isometric view of the automobile data recorder of FIG. 1, showing the display in an idle position.

FIG. 4 is similar to the FIG. 3, but showing the display being used.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

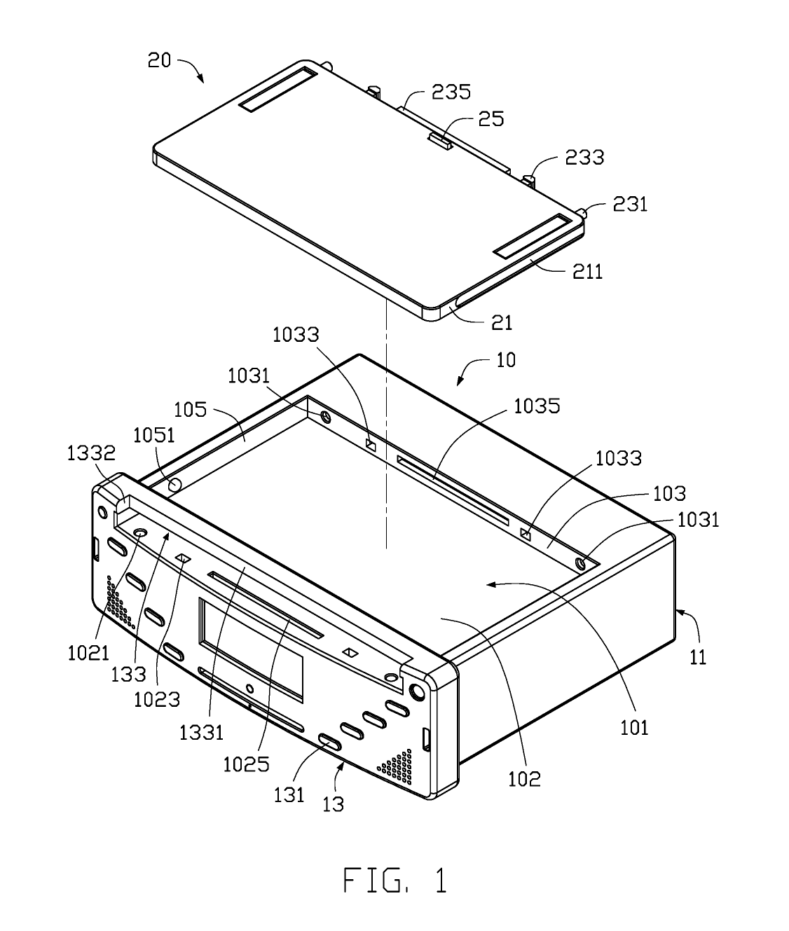

FIG. 1 illustrates an automobile data recorder including a bracket 10 and a display 20.

The bracket 10 can include a base 11 and an operation board 13 secured to the base 11.

The base 11 defines a receiving recess 101 configured to receive the display 20.

The receiving recess 101 has a bottom wall 102, a rear wall 103, and two sidewalls 105. In at least one embodiment, the bottom wall 102 is substantially perpendicular to the rear wall 103 and each sidewall 105, and the rear wall 103 is substantially perpendicular to each sidewall 105. The rear wall 103 defines two positioning slots 1031, two latching slots 1033, and a receiving slot 1035. A protrusion 1051 extends from each sidewall 105 towards the other sidewall 105. A plurality of electronic assemblies, such as circuit board and storage, is secured to the base under the receiving recess 101.

The operation board 13 has a plurality of operation buttons 131 configured to handle the display 20. The receiving recess 101 extends through the operation board 10. The bottom wall 102 defines two positioning holes 1021, two latching holes 1023, and a coupling slot 1025. The positioning holes 1021, latching holes 1023, and coupling slot 1025 are adjacent to the operation board 13. The operation board 13 defines a holding slot 133 communicating with the receiving recess 101. The holding slot 133 has a holding surface 1331 and two opposite limiting surfaces 1332. In at least one embodiment, each holding surface 1331 and the limiting surface 1332 is substantially perpendicular to the bottom wall 102, and each limiting surface 1332 is substantially perpendicular to the holding surface 1331.

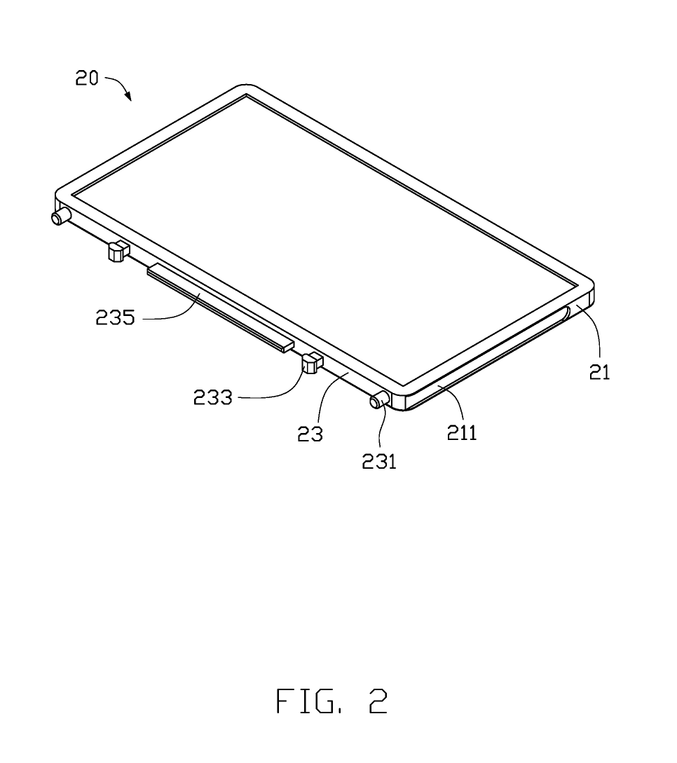

FIG. 2 illustrates that the display 20 can include two side plates 21 and a rear plate 23 connected to the two side plates 21. Each side plate 21 is substantially perpendicular to the rear plate 23. Each side plate 21 defines a sliding slot 211. The sliding slot 211 extends to the rear plate 23. Two positioning posts 231, two latching portions 233, and a connector 235 extend outwards from a side of the rear plate 23. The connector 235 is coupled to the coupling slot 1025 to electronically couple the display 20 to the bracket 10. A block extends from the display 20 and is configured to expediently move the display 20. A distance between the two side plates 21 is slightly less than a distance between the two limiting surfaces 1332.

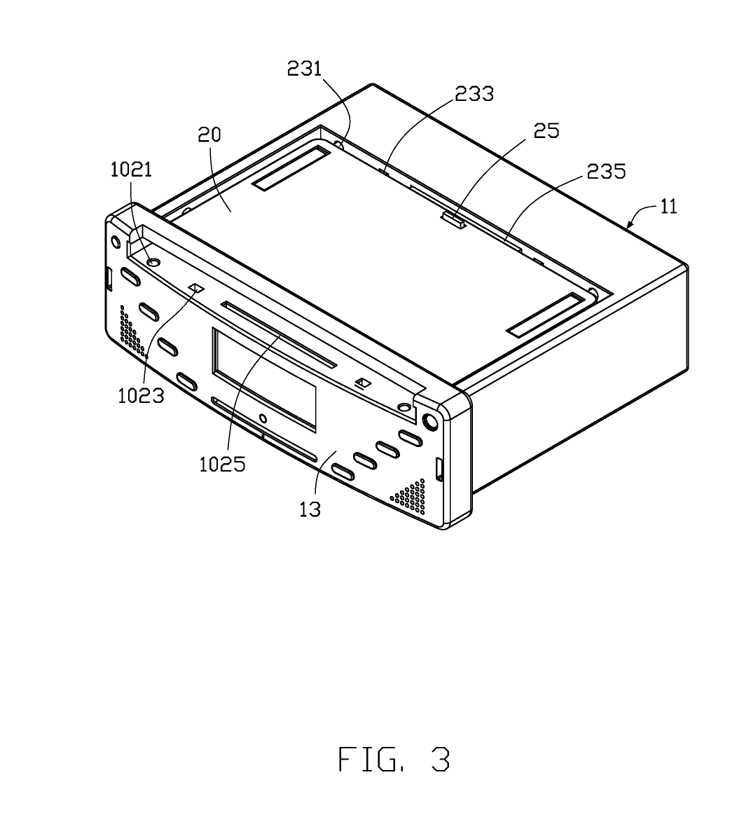

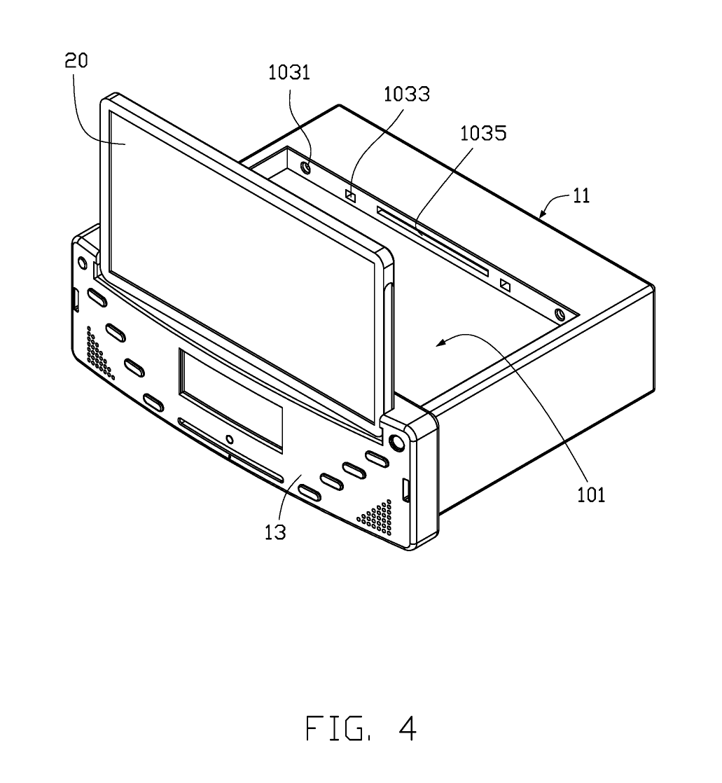

FIG. 3 and FIG. 4 illustrates when in assembly, the display 20 is positioned in the holding slot 133 with the positioning post 231 aligned to the positioning hole 1021, the latching portion 233 aligned with the latching hole 1013, and the connector 235 aligned with the coupling slot 1025. The display 20 is moved downwards until the positioning post 231 is received in the positioning hole 1021, the latching portion 233 is in the latching hole 1023, and the connector 235 is coupled to the coupling slot 1025. The display 20 is limited between the two limiting surfaces 1332 and resists the holding surface 1331. Thus, the display 20 is located in a usable position.

When the display 20 is not used, the display 20 is moved upwards via the block 25 until the display 20 is disengaged from the bracket 10. The display 20 is turned until a screen (not shown) of the display 20 faces the bottom wall 102. The display 20 is moved to align with the receiving recess 101, and the protrusion 1051 is slidably received in the sliding slot 211. The display 20 is moved towards the rear wall 103, until the positioning post is received in the positioning slot 1031, the latching portion 233 is engaged in the latching slot 1033, and the connector 235 is received in the receiving slot 1035. The protrusion 1051 abuts an end of the sliding slot 211. In this position, the display 20 is located in an idle position; the display 20 is completely received in the receiving recess 101, preventing the dust from adhering on the screen.

When the display 20 is moved from idle position to being used, the block 25 is handled to disengage the display 20 from the base 11. The display 20 is slid out of the receiving recess 101 and can be installed in the usable position.

The embodiments shown and described above are only examples. Many details are often found in the art such as the other features of an automobile data recorder with detachable display. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An automobile data recorder comprising:
a bracket comprising a base and an operation board secured to a side of the base; and
a display detachably mounted to the bracket;
wherein the base defines a receiving recess, the display detachably mounted to the bracket in a usable position, wherein the display is vertically mounted to the base and abuts the operation board, or is in an idle position, wherein the display is horizontally mounted to the base and received in the receiving recess.

2. The automobile data recorder of claim 1, wherein the receiving recess extends to the operation board.

3. The automobile data recorder of claim 2, wherein the operation board defines a holding slot communicating with the receiving recess, the holding slot has a holding surface and two opposite limiting surfaces connected to the holding surface, when the display is in the usable position, the display is located between the two limiting surfaces and resist to the holdings surface.

4. The automobile data recorder of claim 1, wherein the receiving recess has a bottom wall, which defining a coupling slot adjacent to the operation board, the display comprises a connector, and when the display is located in the usable position, the connector is coupled to the coupling slot to electronically couple the display to the base.

5. The automobile data recorder of claim 4, wherein the bottom wall further defines two latching holes on two opposite sides of the coupling slot, the display further comprises two latching portions, and when the display is located in the usable position, the latching portions are latched on the latching holes.

6. The automobile data recorder of claim 5, wherein the bottom wall further defines two positioning holes on two opposite sides of the latching holes, the display further comprises two positioning posts, and when the display is located in the usable position, the positioning posts are engaged in the positioning holes.

7. The automobile data recorder of claim 6, wherein the receiving recess further comprises a rear wall substantially perpendicular to the bottom wall, the rear wall defines a receiving slot, two latching slots, and two positioning slots, when the display is located in the idle position, the connector is received in the receiving slot, the latching portions are latched in the latching slots, and the positioning posts are engaged in the positioning slots.

8. The automobile data recorder of claim 1, wherein the receiving recess further has a sidewall and a protrusion extending from the sidewall, the display defines two siding slots, and the protrusion is slidably received in the sliding slot when the display is slid in or out of the receiving recess.

9. The automobile data recorder of claim 1, wherein the display further comprises a block configured to move the display expediently.

10. An automobile data recorder comprising:
A bracket comprising a base and an operation board secured to a side of the base; and
a display detachably mounted to the bracket;
wherein the base defines a receiving recess; the display is horizontally mounted to the base and received in the receiving recess; the display is slidable relative to the bracket to disengage from the receiving recess to a usable position, where the display is vertically mounted to the base and abuts the operation board.

11. The automobile data recorder of claim 10, wherein the receiving recess extends to the operation board.

12. The automobile data recorder of claim 11, wherein the operation board defines a holding slot communicating with the receiving recess, the holding slot has a holding surface and two opposite limiting surfaces connected to the holding surface, when the display is in the usable position, the display is located between the two limiting surfaces and resist to the holdings surface.

13. The automobile data recorder of claim 10, wherein the receiving recess has a bottom wall, which defining a coupling slot adjacent to the operation board, the display comprises a connector, and when the display is located in the usable position, the connector is coupled to the coupling slot to electronically couple the display to the base.

14. The automobile data recorder of claim 13, wherein the bottom wall further defines two latching holes on two opposite sides of the coupling slot, the display further comprises two latching portions, and when the display is located in the usable position, the latching portions are latched on the latching holes.

15. The automobile data recorder of claim 14, wherein the bottom wall further defines two positioning holes on two opposite sides of the latching holes, the display further comprises two positioning posts, and when the display is located in the usable position, the positioning posts are engaged in the positioning holes.

16. The automobile data recorder of claim 15, wherein the receiving recess further comprises a rear wall substantially perpendicular to the bottom wall, the rear wall defines a receiving slot, two latching slots, and two positioning slots, the connector is received in the receiving slot, the latching portions are latched in the latching slots, and the positioning posts are engaged in the positioning slots.

17. The automobile data recorder of claim 10, wherein the receiving recess further has two sidewalls and two protrusions extending from the sidewalls, the display defines two siding slots, and the protrusions are slidably received in the sliding slots.

18. The automobile data recorder of claim 17, wherein the display further comprises a block configured to move the display expediently.
